(19) United States
(12) Patent Application Publication
(10) Pub. No.: US 2016/0143333 A1
(43) Pub. Date: May 26, 2016

(54) NATURALLY SWEET FIBROUS BLEND

(71) Applicant: LFS Products, LLC, Salt Lake City, UT (US)

(72) Inventor: Phillip Craig Cox, Farmington, UT (US)

(21) Appl. No.: 14/735,524

(22) Filed: Jun. 10, 2015

Related U.S. Application Data
(60) Provisional application No. 62/082,846, filed on Nov. 21, 2014.

(51) Int. Cl. A23L 1/30; A23G 3/42; A23G 1/40; A23L 1/236; A23L 2/60

(52) U.S. Cl. CPC A23L 1/3002; A23L 1/2363; A23L 2/60; A23G 1/40; A23G 3/42; A23V 2002/00

(57) ABSTRACT

A naturally sweet fibrous blend can include from 15 wt % to 85 wt % natural isomalto-oligosaccharide, from 10 wt % to 75 wt % by weight of tagatose, and from 0.05 wt % to 20 wt % of a natural sweetener extract that is sweeter than sugar.

The present application claims the benefit of U.S. Provisional Patent Application No. 62/082,846, filed on Nov. 21, 2014, the entirety of which is incorporated herein by reference.

### BACKGROUND

Sucrose, or sugar, has been historically the sweetener of choice, but is considered by many to be unhealthy, particularly when used in greater amounts due to its high caloric value and other properties. Thus, it is not a particularly good sweetener for a product claiming to be healthy and of low carbohydrate content. Furthermore, the over consumption of sugar contributes to heart disease, Type 2 diabetes, and liver disease. Sugar is also one of the leading causes of obesity. Even other natural sweeteners such as brown rice syrup, agave nectar, and crystallized cane juice crystals when used to replace refined sugar and high-fructose corn syrup can be problematic in that they metabolize so similarly to sugar that they have the same negative health drawbacks as refined sugar. It is noted that “sugar” as used herein, unless specifically otherwise noted by name or definition, is considered to be sucrose, table sugar, or the like, i.e. disaccharide of glucose and fructose.

On the other hand, there are many sugar replacements that have been tried. For example, many sweetening food additives are not natural, but are synthetic, such as the artificial sweeteners: aspartame, acesulfame k, saccharin, and sucralose. Such agents have little to no nutritional value and tend to be falling out of favor with consumers. Likewise, sugar alcohols are used in many health food and supplement products with the claim of being natural. However, many people that consume sugar alcohols have stomach related discomfort. Maltitol, which is used in many sugar free products, can only be consumed in small doses. Erythritol, which is used as the primary sweetener in many sweetening formulations with the claim natural, is considered by many consumers to not be a natural product, and also can cause stomach discomfort in some users. One other concern with sugar alcohols is the laxative or digestive problems associated therewith. Of the sugar alcohols, erythritol tends to cause the least amount of digestive related problems, but still cause some discomfort to an appreciable population of users and otherwise potential users.

### DETAILED DESCRIPTION

As mentioned, sugar has been the sweetener of choice for most products for a very long time, i.e. centuries. However, irrespective of the many health problems associated therewith, sugar is still considered to be a good benchmark when comparing alternative sweeteners as it relates to taste, browning under heat for a pleasant appearance, bulking for foods or beverages, etc. In other words, if one could provide a sweetener that looks, tastes, bulks, browns, etc., in a manner that is similar to sugar (particularly with respect to taste), and that same product is healthier, that sweetener would enjoy a competitive advantage in the marketplace.

In accordance with a desire to move away from sugar to more healthy alternatives, it would be desirable to provide a general purpose sweetener that can be about as sweet or even sweeter than sugar, can be healthier than sugar, does not cause stomach discomfort (like occurs in some users with sugar alcohols), browns like sugar, is versatile in use such as for use in a wide variety of beverages and foods, has solubility characteristics in water similar to that of sugar, and/or bulks similar to sugar, etc.

In one example of the present disclosure, a naturally sweet fibrous blend suitable for sweetening food or beverage products can include from 30 wt % to 90 wt % isomalto-oligosaccharide; and from 10 wt % to 70 wt % tagatose. If additional sweetness is desirable, sweetening extracts can be added in certain specific examples. In further detail, the present disclosure provides a food product sweetened by the naturally sweet fibrous blend. Formulations that can be prepared that may or may not include the added extract can include from 30 wt % to 40 wt % isomalto-oligosaccharide, and from 60 wt % to 70 wt % tagatose; or from 40 wt % to 60 wt % isomalto-oligosaccharide, and from 40 wt % to 60 wt % tagatose; or from 60 wt % to 70 wt % isomalto-oligosaccharide, and from 30 wt % to 40 wt % tagatose; or from 70 wt % to 90 wt % isomalto-oligosaccharide, and from 10 wt % to 30 wt % tagatose.

In another example, a naturally sweet fibrous blend can include from 10 wt % to 75 wt % natural isomalto-oligosaccharide, from 15 wt % to 85 wt % by weight of tagatose, and from 0.1 wt % to 20 wt % of a natural sweetener extract that is typically sweeter than sugar. In further detail, the present disclosure provides a food product sweetened by the naturally sweet fibrous blend. In further detail, a formulation with added extract in accordance with this principle can include isomalto-oligosaccharide at from 10 wt % to 75 w %, tatagose at from 15 wt % to 85 wt %, stevia extract at from 0.2 wt % to 4 wt %, and monk fruit extract at from 0.2 wt % to 4 wt %. In yet another example, a formulation with added extract in accordance with this principle can include isomalto-oligosaccharide at from 15 wt % to 75 w %, tatagose at from 15 wt % to 75 wt %, stevia extract at from 1 wt % to 15 wt %, and monk fruit extract at from 1 wt % to 15 wt %. In an even more specific example, a sweetener fiber blend with added extract to be used as a sugar substitute may contain from 60 wt % to 70 wt % isomalto-oligosaccharide, from 30 wt % to 35 wt % tagatose, from 0.1 wt % to 3 wt % by weight stevia extract, and from 0.1 wt % to 3 wt % by weight monk fruit extract. In another more specific example, a sweetener fiber blend with added extract to be used as a sugar substitute may contain from 40 wt % to 60 wt % isomalto-oligosaccharide, from 40 wt % to 60 wt % tagatose, from 0.1 wt % to 3 wt % by weight stevia extract, and from 0.1 wt % to 3 wt % by weight monk fruit extract. In still another specific example, a sweetener fiber blend to be used as a sugar substitute may contain from 70 wt % to 85 wt % isomalto-oligosaccharide, from 10 wt % to 30 wt % tagatose, from 0.1 wt % to 3 wt % by weight stevia extract, and from 0.1 wt % to 3 wt % by weight monk fruit extract.

In another example, a method of sweetening a food product without added sugar can include formulating a food product, and admixing into the food product, as part of the formulating step, a naturally sweet fibrous blend comprising at least isomalto-oligosaccharide and tagatose. In some examples, additional sweeteners can be added to raise the sweetness to at or above that of sugar.

When using a natural sweetener extract, this component can include one or both of stevia extract and/or monk fruit extract. One advantage of using both the stevia extract and the monk fruit extract is that both are powerful sweetening agents (both significantly sweeter than sugar); however, both have a unique aftertaste that can be undesirable in large quantities. By using both extracts, less of each can be included to obtain an acceptable level of sweetness while minimizing the respective aftertastes of each of these two extracts. That being described, using both of these extracts is not required because only a minimal amount of enhanced sweetness may be desired to cause the blend of isomalto-oligosaccharide and tagatose to become as sweet or even sweeter than natural sugar. On the other hand, if the desire is to provide some sweetness, but there is not a requirement to be as sweet as sugar, then the blend of isomalto-oligosaccharide and tagatose can be used without an added extract. In other words, the highly fibrous blend of isomalto-oligosaccharide and tagatose may already be close to sweet as sugar (greater than 70% as sweet as sugar), even though such blends are also highly fibrous in nature. If used, only a minimal amount of a natural sweetener extract may be desired to push the sweetness profile of this blend over the top to become as sweet as or even sweeter than sugar. Because only a small amount of natural sweetener extract is likely used to cause the full blend to be as sweet as sugar, the unpleasant aftertastes sometimes associated with these extracts can be mostly avoided. Furthermore, these aftertastes can even further be reduced by using even lower amounts of both extracts together in combination, i.e. two or more natural sweetener extracts such as stevia extract and monk fruit extract.

In certain examples, the various blends can be prepared so that the isomalto-oligosaccharide is present at a greater concentration than the tagatose. In another example, if present, the blend can be prepared so that the stevia extract and the monk fruit extract are added at about the same concentration; or the stevia extract can be added at a greater concentration than the monk fruit extract. As a replacement for an artificial sweetener, the above percentages may also be used with the caveat that adjustments in the percentages may be made depending on the sweetness desired. For drink mixes and other products where greater sweetness is desired, the percent of stevia and/or monk fruit extracts may be raised for example. Alternatively, for chocolate, it would not be uncommon to select a lower concentration of stevia and/or monk fruit extracts, e.g., less than 0.5 wt % (0.25 wt % stevia extract and 0.25 wt % monk fruit extract, for example) or slightly more broadly, from 0.1 wt % to 1 wt %.

It is noted that when referring to the various formulations of naturally sweet fibrous blends of the present disclosure, relative concentrations are provided in terms of the sweetener composition per se, equaling 100 wt %. However, when the sweetener is blended into a food or beverage product in accordance with examples of the present disclosure, it is noted that those relative concentrations will remain the same with respect to one another as part of the sweetener, but will be greatly reduced in terms of the final concentration in the food or beverage product. As a simple example, a naturally sweet fibrous blend of 100 wt % sweetener when admixed with coffee may only be present in the coffee at 1 wt %, but the relative concentrations of each ingredient with respect to one another in the naturally sweet fibrous blend per se (minus the coffee, cream, etc.) remains the same (unless other additives are included that bolster one or more component of sweetener blend). Thus, unless the context dictates otherwise, most weight percentages herein relate to the naturally sweet fibrous blend. However, when added to food or beverages, lower concentrations can be provided on a case by case basis (such as in the Examples) as would be apparent to one skilled in the art.

In further detail, a naturally sweet fibrous blend with a unique pleasant mouth feel and taste that does not taste like an artificial sweetener (with a chemical aftertaste or back note taste) has thus been prepared by blending various ingredients as outlined in the present disclosure. With these blends, a minor aftertaste that does exist can be minimal, and even the aftertaste by some has been reported to be fresh and clean as well as distinctly different than that of sugar alcohols and artificial sweeteners. Intense sweeteners blended with sugar alcohols and artificial sweeteners do not provide a similar lingering fresh, clean, or cool back note in the mouth. Furthermore, because of the use of isomalto-oligosaccharide in particular in larger quantities, this fibrous component provides bulking properties that are healthier than traditional sweetening agents, in that it offers prebiotic fiber benefits. Also, because the blends of the present disclosure can be free of sugar alcohols, and because isomalto-oligosaccharide does not cause bloating like other fibers, these blends do not typically cause digestive distress in a typical user.

As mentioned, regarding the formulations of the present disclosure, two primary ingredients are described for blending, namely isomalto-oligosaccharides and tagatose. These primary ingredients may then further be blended with at least one natural sweetener extract, such as stevia extract, monk fruit extract, or the like, or combinations thereof.

Natural isomalto-oligosaccharide (IMO) as used in the naturally sweet fibrous blend of the present disclosure is typically prepared from enzymatic conversion of starch, and is a mixture of short-chain carbohydrates made up on glucose molecules which are linked with each other through a digestion resistant bonding. More specifically, the term oligosaccharide refers to carbohydrates that are larger than di- or tri-saccharides, but smaller than polysaccharides (greater than 10 units), i.e. oligosaccharide encompasses from 4 to 10 units. Isomalto-oligosaccharides or IMO, specifically, are glucose oligomers with α-D-(1,6)-linkages, including among others isomaltose, panose, isomaltotetraose, isomaltopentaose, nigerose, kojibiose, and higher branched oligosaccharides. Thus, IMO is defined as more than one specific compound. This compound differs from starch in general. The term “starch” is defined as an oligosaccharide that can be hydrolyzed or digested into glucose molecules. One source of isomalto-oligosaccharide is from BioNutra, a Canadian Company, under the trade name Vitafiber™. In further detail, isomalto-oligosaccharide is a soluble naturally sweet dietary low calorie fiber approximately 60% to 70% as sweet as sugar, and has a low caloric content of about 2 calories per gram. Furthermore, this compound is fibrous and has a high tolerability that is much higher than most other fibers. Therefore, it can be consumed in a larger volume without causing stomach discomfort or distress. Even though isomalto-oligosaccharide provides a pleasant subtle sweetness, as mentioned, it also provides fiber of a type that provides very low gastric or digestive distress, if any. A fiber that causes digestive distress would not work well as a sweetener. This particular fiber has the dual benefit of providing all the same benefits of a psyllium husk, without the bloating; and furthermore, is naturally sweet. As far as fiber content is concerned, isomalto-oligosaccharide comprises about 95 wt % fiber.

Isomalto-oligosaccharide has many other advantageous properties, including its ability to provide a dietary fiber that is also a bulking agent, and which can provide an increased satiety or feeling of fullness. Isomalto-oligosaccharide also provides a pleasant smooth taste with increases viscosity in semisolid products, which can be used in cooking, providing browning of products when baked or otherwise cooked. Isomalto-oligosaccharide is pH stable over a wide range of pH values, i.e. from about a pH of 2-9, and also provides the benefit of being a flavor enhancement and flavor masking agent to reduce the taste of off-flavors including astringent flavor in sweetener extracts, including stevia and monk fruit extracts. Isomalto-oligosaccharide is available as a powder or syrup, is water soluble, and can be used as a fat replacer to replace some of the bulk and volume of sugar in the blends of the present disclosure. In still further detail, isomalto-oligosaccharide also has properties suitable for providing food sweetness, as well as a good fiber source, as mentioned. As representative examples, this compound can be used favorably in breakfast cereals, dairy products of all kinds, candies, meal replacement formulations, fruit juices, snack foods, sauces and toppings, dressings, frozen desserts, coffee and other hot beverages, or in meat products, to name a few. In other words isomalto-oligosaccharide can be used as a complete food supplement with little, if any, limitation as to its utility.

In the sweetening industry, the use of a fiber is not typically associated with achieving sweetness. Fiber is generally considered fiber and is added for its fiber benefits. Likewise, sweeteners are added to impart sweetness. A sweetener product that can mirror many health benefits of fiber products, such as Metamucil or Benefiber, is not the norm. By merely adding fiber to an existing sweetener, the naturally sweet fibrous blend of the present disclosure is not very well approximated because the isomalto-oligosaccharide actually contributes to the taste and sweetness of the blends described herein. Furthermore, as most natural and artificial sweeteners are considered to be harmful, it is notable that this fiber/sweetener, isomalto-oligosaccharide, is not. Over consumption of sugar is suggested by many health and nutrition organizations to harm the metabolism, to cause insulin resistance and cancer, and is a leading contributor to obesity. Artificial sweeteners are associated with damaging the gut microbiome as well as causing other problems of note in recent years. Additionally, a majority of natural and artificial sweeteners do not provide any positive benefits to health, nor do they provide any sense of satiety or feeling of being full. The naturally sweet fibrous blends of the present disclosure, with blended isomalto-oligosaccharide, provide satiety benefits, benefits associated with fiber, low calorie benefits, and the ability to significantly reduce the intake of sugar generally. That being stated, isomalto-oligosaccharide is not as sweet as sugar, e.g., about 60% to 70% as sweet as sugar, so to balance out the sweetness component, other additives can be blended therewith in accordance with examples of the present disclosure.

Tagatose, as second primary component of the naturally sweet fibrous blends of the present disclosure, is a functional sweetener that is a naturally occurring monosaccharide, specifically a hexose. Its IUPAC name is (3S,4S,5R)-1,3,4,5,6-Pentahydroxy-hexan-2-one and its CAS Registry Number is 17598-81-1. It can be found in small amounts in some fruits, cacao, and dairy products, and is very similar in texture to sucrose (table sugar); and in fact, is as high as 92% as sweet as sugar with only 38% of the calories. To illustrate, table sugar has 4.0 kcal/g and tagatose has 1.5 kcal/g. Tagatose is beneficial for use in the compositions of the present disclosure because it does not have significant aftertaste, brings the sweetness level of the isomalto-oligosaccharide up due to its “close to sugar” sweetness level, and also because it provides flavor enhancing and masking properties for other added extracts. Tagatose also has the benefit that it does not decay the teeth (approved as a tooth-friendly ingredient) and is generally recognized as safe (GRAS) by the USDA, the World Health Organization of the United Nations and many other nations. Tagatose can be produced from galactose thorough natural processes. Since it is metabolized differently from sucrose, tagatose has a minimal effect on blood glucose and insulin levels. Thus, by blending isomalto-oligosaccharide with tagatose, a blend that is less sweet than sugar (but within a reasonable range of sweetness) can be prepared that is high in fibrous content, is tooth friendly, has bulk and browning properties similar to sugar, and is much healthier than sugar. Furthermore, tagatose does not show up as a sugar on a nutritional facts table and does not digest as a sugar. Thus, it has a low glycemic index. That being described, in some specific examples, there is some benefit in trying to keep the concentration of tagatose low because tagatose is a carbohydrate, and it is more desirable to reduce carbohydrates that are not offset by fiber. Thus, in one example, the present disclosure provides blends of isomalto-oligosaccharide and tagatose where the concentration of isomalto-oligosaccharide is greater than the concentration of tagatose.

Regarding the blend of isomalto-oligosaccharide and tagatose, by leaving one of these ingredients out of the final formulation, the blend changes in a negative manner, i.e. the benefits are diminished or removed. For example, if one removes the isomalto-oligosaccharide but uses tagatose alone (typically with the other extract(s)), the flavor will be acceptable but the prebiotic fiber and active carbohydrate features provided by isomalto-oligosaccharide are removed, making the blend less desirable. If, on the other hand, one removes the tagatose and uses more isomalto-oligosaccharide (typically with the other extract(s)), the flavor profile will not be as good because stevia extract and/or monk fruit extract (or other sweetener) may have to be increased, leaving a poor aftertaste, which is much less desirable. Furthermore, because the blend of isomalto-oligosaccharide and tagatose it is slightly less sweet than sugar, by adding a natural sweetener extract, or a combination of natural sweetener extracts to the blend, a product as sweet or sweeter than sugar can be prepared while maintaining the benefits provided by isomalto-oligosaccharide and tagatose blend.

Regarding the natural sweetener extract, in one example, one or both of stevia extract and/or monk fruit extract can be used. These two extracts are powerful sweeteners on the one hand, but have a very poor aftertaste that is repulsive to many users. Because of the poor aftertaste, the use of large quantities which might otherwise be desirable to use for bulking and browning cannot be provided by stevia and/or monk fruit extracts, at least in accordance with the present disclosure where a more pleasant taste is one of the advantages of the present fibrous blends, i.e. if you use too much the aftertaste is overpowering. By using a small amount of a natural sweetener extract, just enough sweetness can be added to the isomalto-oligosaccharide and tagatose blend to bring it up to the sweetness of sugar (or exceed the sweetness of sugar), while not adding too much aftertaste so as to overpower the taste masking properties of the tagatose and/or the isomalto-oligosaccharide. Still further, by blending even smaller amounts of both stevia extract and monk fruit extract together, because they both provide a different aftertaste, the overall aftertaste can be even further reduced.

Steviol is the basic building block of stevia's sweet glycosides. Stevia extract has been found to assist in rounding out the properties of the isomalto-oligosaccharide such that there is provided a food additive supplement as sweet as, or sweeter than, sucrose, but still providing the benefits of fiber from the isomalto-oligosaccharide. Stevia is a sweetener extracted from the leaves of the plant species Stevia rebaudiana. The active compounds of stevia are steviol glycosides (mainly stevioside and rebaudioside), which have up to 150 times the sweetness of sugar and are heat and pH stable and are not fermentable. Stevia also has a negligible effect on blood glucose.

Monk fruit, or Siraitia grosvenorii, is derived from a herbaceous perennial vine of the Cucurbitaceae (gourd) family, native to southern China and northern Thailand. The plant is cultivated for its fruit, whose extract is about 300 times sweeter than sugar (and can be even sweeter if a higher concentration of mogroside-5 is present) and has been used in China as a natural low-calorie sweetener for cooling drinks, and in traditional Chinese medicine, to treat diabetes and obesity. The plant's fruit is often called in English language publications luo han guo or lo han kuo (from the Chinese luóhàn gu\check{o}). It may also be called la han qua (from Vietnamese la hán qu [symbol] ), arhat fruit, Buddha fruit, or monk fruit.

For purposes of this disclosure, the terms “stevia” and “stevia extract” may be used interchangeably, and “monk fruit” and “monk fruit extract” may be used interchangeably, as both refer to the extract obtained from the processing of the leaves or fruit of the plant. Any technique can be used to extract the leaves or fruit, respectively, as is known in the art of extraction. Either liquid extractions or powder extractions can be used in accordance with examples of the present disclosure, and the purity level of each is typically greater than about 75 wt %, greater than 80 wt %, greater than 85 wt %, greater than 90 wt %, greater than 95 wt %, or greater than 98 wt %. For example, Stevia Extract Reb A 95 is about 95 wt % purity, Stevia Extract Reb A 98+ extract is greater than about 98 wt %, and Monk Fruit Extract can be at various concentrations as well, but in one case is about 80 wt % pure. To illustrate, Rebaudioside A (Reb A) has the least bitterness of all the steviol glycosides in the Stevia rebaudiana plant. To produce Rebaudioside A commercially, stevia plants can be dried and subjected to a water process, and in some examples, the various glycosides can be further separated and purified via crystallization techniques, typically using methanol or ethanol as a solvent. There are other processes for extracting sweet compounds from stevia by column extraction at temperatures from 0° C. to 25° C., followed by purification by nanofiltration. Such processes can include a microfiltration pretreatment step used to clarify the extract. Purification can also be carried out by ultrafiltration followed by nanofiltration, for example. In another example, through solvent extraction, a powder containing 80 wt % mogrosides can be obtained from monk fruit, the main mogroside being mogroside-5 (esgoside). Other extraction techniques can likewise be used.

Isomalto-oligosaccharide and tagatose blended together (with our without one or both of monk fruit extract and stevia extract in the proportions described herein to generate a naturally sweet fibrous blend or blend that is as sweet or sweeter than sugar), has similar bulk and browning properties of sugar, has little aftertaste that is pleasant, etc. By itself, isomalto-oligosaccharide is not sweet enough to substitute sugar. By themselves, Monk Fruit or Stevia are too sweet to be used as a sugar substitute, and have a very strong aftertaste. Tagatose is a natural filler that can replace sugar to some degree, but is not quite as sweet as sugar. It does have, however, good taste masking properties. Together, by blending the compounds described herein at appropriate ratios, enhanced sweetener properties while reducing unwanted aftertaste can occur, providing excellent texture (similar to sugar). Additionally, at some ratios, the sweetness per volume of granules with the added extract can be similar to that of sugar, e.g. the blend can provide a close to a 1:1 by volume replacement for sugar. To illustrate, a blend that is from 95% to 150% as sweet as sugar can be formulated to have 75% to 125% the volume of sugar, or from 90% to 110% the volume of sugar, or about 100% the volume of sugar (i.e. about 1:1 by volume). In another example, a blend that is the same sweetness as sugar can be formulated to have 75% to 125% the volume of sugar, or from 90% to 110% the volume of sugar, or about 100% the volume of sugar (i.e. about 1:1 by volume). In other words, in one example, the blend of the present disclosure can be formulated so as to provide a sweetener that can replace sugar in volume and sweetness.

As other advantages, the present formulations actually provide some nutritional value to the user. The average American only gets 15 grams of fiber per day. On average, women should consume 25 grams of fiber, and men should consume 38 grams of fiber. Furthermore, a person needs 14 grams of fiber per 1,000 calories consumed (USDA). The naturally sweet fibrous blend of the present disclosure provides the same or similar nutritional benefits of many fiber supplements. Thus, the fiber sweetener blend of the present disclosure provides a supplement having several beneficial properties, including one or more of the following: i) helps restore and maintain regularity; ii) helps maintain healthy blood sugar levels; iii) helps maintain healthy cholesterol levels; iv) helps improve mineral absorption; v) helps prevent constipation; vi) helps maintain health blood sugar levels already within normal range; vii) improves gastrointestinal health; and or viii) helps bolster the intestinal micro-flora. Furthermore, because the fiber comes from isomalto-oligosaccharide, this also provides a good fiber source with one of the lowest or least amount of flatulence production, and also has one of the highest tolerability (48 grams per day) of fiber.

In accordance with this, when formulating isomalto-oligosaccharide, tagatose, and the natural sweetener extract(s), what was not expected was to be able to generate a result where, in studies conducted, a majority of consumers actually preferred the naturally sweet fibrous blend's mouth taste to sugar alcohols, artificial sweeteners (such as aspartame), intense natural sweeteners alone, and in some cases, even natural sugars. See Examples 14-18 below. Furthermore, by using naturally sweet fibrous blend of the present disclosure in baking, confectionery, and powdered products, a sweetener blend provided products that did not offend consumers taste expectations, and it did not cause many consumers to believe they are tasting something other than sugar. Unlike other sugar substitutes, this naturally sweet fibrous blend, when adjusted correctly as per a specific recipe or even directly off the shelf when blended as an “average” for many applications, does not taste like an artificial sweetener, artificial sweetener blend, or even natural sweetener blend. This naturally sweet fibrous blend allows for sugar free, artificial sweetener free, sugar alcohol free products to be prepared, including for chocolate which is challenging, that are pleasant to taste. Furthermore, these formulations can be prepared to be all natural, non-GMO, and offers prebiotic fiber benefits from both the isomalto-oligosaccharide and tagatose ingredients of the product.

Further advantages of the naturally sweet fibrous blends of the present disclosure are that its taste and bulk are acceptable for use in baking mixes and confectionery items such as chocolate and kettle corn, to name a few. For example, when the blend is adjusted for a specific food (dessert, breakfast food, etc.) or beverage (coffee, fruit drink, etc.), or when the blend is simply used off the shelf without specific adjustment, the naturally sweet fibrous blend can provide not only a bulking and browning effect (in baked goods in particular), but a very minimal and/or pleasant aftertaste, unlike artificial sweeteners, sugar alcohols, and intense natural sweeteners. Furthermore, because there are multiple, e.g., two, three, or often four, ingredients in the blends of the present disclosure, some adjustment of ratios of ingredients for a specific use may provide an even more desirable result for that specific food or beverage compared to an “off the shelf” blend that is prepared as more of an average that can be used across a full spectrum of food or beverage applications. Either approach provides acceptable results, but a more finely tuned blend for a specific application can provide an even more desirable taste, aftertaste, browning, and/or bulking effect. As an example, by blending slightly modified ratios of the various ingredients of the naturally sweet fibrous blend of the present disclosure for various foods, very desirable food tasting results can be achieved.

In short, as individual ingredients, isomalto-oligosaccharide, tagatose, stevia extract, and monk fruit extract do not offer the mouth feel and pleasant taste discovered by using isomalto-oligosaccharide and tagatose together (often with three or all four of these ingredients together). Isomalto-oligosaccharide, although a fiber that has sweetness, is too subtle to be used as a standalone sweetener. Tagatose by itself is almost as sweet as sugar but has drawbacks in use for baking, and does not offer the same pleasant cool or fresh aftertaste offered by the blend. Both stevia extract and monk fruit extract are too intense by themselves or even blended together to replace sugar, and both are considered by most consumers to have a very poor aftertaste. Even when stevia extract and monk fruit extract are used in a sweetener blends with sucralose and erythritol type sweeteners, the taste profiles of those blends are not typically favorable and do not allow for a wide universal use in replacing sugar, especially in something like chocolate.

Furthermore, by combining isomalto-oligosaccharide and tagatose (often with one or both of stevia extract and/or monk fruit extract), a superior fibrous sweetener having the following advantages can be realized. First, by using the isomalto-oligosaccharide and tagatose in the blend, the formulation can be used to replace (or at least partially replace) sugar without the addition of unnecessary fillers and sweeteners, such as dextrose or maltodextrin (or Erythritol). With fiber being such a highly desired feature in the market, by using isomalto-oligosaccharide in the blend, a claim of “high fiber” can be made for a sweet product, which is not a common primary feature or benefit for sweeteners, whether natural or artificial. Also, in examples where one is using both stevia extract and monk fruit extract, by adding the appropriate blend or ratio of these two sweeteners, aftertaste can be further masked even with stronger sweetness profiles (by using less of two ingredients rather than more of one ingredient), and the blend of isomalto-oligosaccharide and tagatose goes from being less than the sweetness of sugar to equal or greater in sweetness compared to sugar. The use of isomalto-oligosaccharide and tagatose also provides the benefit of providing a favorable browning effect that is similar to sugar when used in cooking.

Stated in a more general way in comparison to sugary products, the nutritional value of the naturally sweet fibrous blends of the present disclosure include: the blend contains a tolerant prebiotic fiber, and the blend does not contain any sugar alcohols. By providing sweetness and at the same time, removing sugar (while adding fiber) and calories, a desirable combination of traits is achieved. This is because harmful carbohydrates can be reduced because of the high fiber content, and furthermore, products with a lower glycemic index can be prepared. Essentially, unhealthy products can be made into healthy products by using the naturally sweet fibrous blends of the present disclosure, without sacrificing the taste that consumers of sugar are accustomed to, at least in view of a majority of taste testers.

Non-limiting examples of products that can be prepared with the naturally sweet fibrous blends of the present disclosure including the following: baking mixes such as mixes for brownies, pancakes, sugar cookies, cakes, muffins, or breads; drink mix concentrates such as mixes for hot chocolates, flavored drink mixes (e.g. substitute Chyrstal Light® type sweetened drinks), smoothie powder blends, or energy drink powders; ready to drink liquid beverages such as soft drinks, sport beverages, alcoholic beverages, meal replacement drinks, fruit juices or beverages, or vegetable juices or beverages; supplements such as meal replacements shake powders, protein powders, pre-work out powders, post work out powders, BCAA powders, amino acid powder blends, or super food blend powders; snack foods; breakfast foods such as cereals, oatmeal, or breakfast bars; dairy products such as milks, ice creams, yoghurts, or cheeses; condiments such as jams, jellies, catsups, or dressings; chocolates; or candy, to name a few.

In describing and claiming the present invention, the following terminology will be used.

The singular forms “a,” “an,” and “the” include plural referents unless the context clearly dictates otherwise. Thus, for example, reference to “a natural sweetener extract” includes reference to one or more of such extracts.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. For example, in one embodiment, the degree of flexibility can be within about ±10% of the numerical value. In another embodiment, the degree of flexibility can be within about ±5% of the numerical value. In a further embodiment, the degree of flexibility can be within about ±2%, ±1%, or ±0.05%, of the numerical value.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps. It is understood that reference to any one of these transition terms (i.e. “comprising,” “consisting,” or “consisting essentially”) provides direct support for replacement to any of the other transition term not specifically used. For example, amending a term from “comprising” to “consisting essentially of” would find direct support due to this definition.

As used herein, a plurality of local anesthetics, compounds, and/or heating mechanisms may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to 15 percent by weight” should be interpreted to include not only the explicitly recited values of about 1 to about 15 percent by weight, but also include individual values and sub-ranges within the indicated range. Thus, included in this numerical range are individual values such as 2, 3.5, and 4 and sub-ranges such as from 1-3, from 2-4, and from 3-5, etc. Furthermore, such an interpretation should apply regardless of the breadth of the range or the characteristics being described.

Embodiments of the present disclosure will be described with reference to the following Examples which are provided for illustration purposes only and should not be used to limit the scope of or construe the invention.

### EXAMPLES

### Example 1

Several naturally sweet fibrous blends are prepared in accordance with Tables 1A, as follows:

TABLE 1A
Naturally Sweet Fibrous Blends with Natural Extract

| | Blend ID | | | | | | | | |
|---|---|---|---|---|---|---|---|---|---|
| | 1 | 2 | 3 | 4 | 5 | 6 | 7 | 8 | 9 |
| | (wt %) | (wt %) | (wt %) | (wt %) | (wt %) | (wt %) | (wt %) | (wt %) | (wt %) |
| Isomalto- | 75 | 80 | 83 | 15 | 15 | 50 | 65 | 75 | 50 |
| oligosaccharide | | | | | | | | | |
| Tagatose | 23 | 19 | 16.5 | 69.5 | 69.5 | 48 | 33 | 23.5 | 48.5 |
| Stevia Extract | 1 | 0.5 | 0.25 | 15 | .05 | 1 | 1 | 1.5 | — |
| Monk Fruit | 1 | 0.5 | 0.25 | .05 | 15 | 1 | 1 | — | 1.5 |
| Extract | | | | | | | | | |

Additionally, Several naturally sweet fibrous blends are prepared which do not include natural extract in accordance with Tables 1B, as follows:

TABLE 1B
Naturally Sweet Fibrous Blends without Natural Extract

| | Blend ID | | | | | |
|---|---|---|---|---|---|---|
| | 10 | 11 | 12 | 13 | 14 | 15 |
| | (wt %) | (wt %) | (wt %) | (wt %) | (wt %) | (wt %) |
| Isomalto- | 75 | 90 | 85 | 30 | 50 | 65 |
| oligosaccharide | | | | | | |
| Tagatose | 25 | 10 | 15 | 70 | 50 | 35 |

Blends 1 and 8 can be used generally, but in one example, can be used as a naturally sweet fibrous blend which has a very high prebiotic fiber content per serving. Because of the high fiber content, it will typically utilize a greater volume of blend per serving to sweeten similarly to sugar. This blend works well in coffee, tea, smoothies, breakfast cereals, and oatmeal.

Blends 2 and 3 can be used generally, but in one example, these blends can be used particularly well in chocolate and other confectionery items that use chocolate, e.g., where the stevia extract and monk fruit extract are used to increase sweetness but where the use of too much extract my intensify the natural cocoa nibs bitter taste.

Blends 4 and 5 can be used generally, but in one example, may be particularly suitable as a pre workout supplement which can be taken as part of other supplement blends (weight management protein powders, etc.) where less calories and fiber is desired. This naturally sweet fibrous blend would provide a more intense sweetness because of the possible small serving size. For example, pre workout serving sizes can be around 6 grams but go up to 28 grams with the bulk of the ingredients being amino acids. The difference or choice of whether to use Blend 4 or Blend 5 could be determined by how well either each of these blends work with the natural flavors of the other ingredients. For example, a blueberry or cherry flavor may react better with one intense sweetener versus the other.

Blends 6 and 9 can be used generally, but in one example, would be a very desirable blend for use in making brownies, muffins, cookies, and syrups. The blend is excellent for these types of uses, with a clean and pleasant taste.

Blend 7 can be used generally as well, but in one example, is an excellent blend for use as a standalone product in stick packets, square packets, or canisters for adding to coffee, teas, cereals, oatmeal, and smoothies.

Blends 10-12 and 15 can be used generally, but in one example, can be used where some additional sweetness is desired in addition to the added fiber content provided by the isomalto-oligosaccharide, such as in foods or beverages wanting a very high prebiotic fiber content per serving, but not as much added sweetness.

Blend 13 and 14 can be used generally, but in one example, can be used when a product already closer to the sweetness of sugar is formulated but which lacks in fiber content. Added sweetness provided by a natural extract may not be needed or desired in all examples, e.g., some chocolate formulations.

### Example 2

A conventional brownie mix prepared with sorghum flour, cocoa potato starch, sugar, egg whites, natural vanilla flavor, sea salt, baking powder, baking soda, and about 10 grams of sugar that a brownie having about 100 calories per serving can be modified to reduce calories. The same mix can prepared and replaced by 10 grams of a naturally sweet fibrous blend of the present disclosure (similar to that from Blend 6 or 7 in Table 1). A brownie with essentially the same taste having only about 60 calories per serving can result. For comparative purposes, granulated sugar has 400 calories per 100 grams whereas the naturally sweet fibrous blend of the present disclosure can have an average caloric content of less than one half, i.e. about 180 calories per 100 grams, depending on the exact formulation.

### Example 3

A conventional sugar cookie mix prepared with enriched wheat flour (wheat flour, niacin, reduced iron, thiamin mononitrate, riboflavin, folic acid), sugar, baking powder, salt, and baking soda as a conventional sized cookie having about 5 grams of sugar may have about 60 calories. The same mix can be prepared, except that the sugar (or 5 grams of the sugar) is replaced by 5 grams of the naturally sweet fibrous blend (similar to Example 6 or 7 in Table 1), resulting in a sugar cookie having about 35 calories. For comparative purposes, granulated sugar has 400 calories per 100 grams whereas the naturally sweet fibrous blend of the present disclosure has an average caloric content of less than one half, i.e. about 180 calories per 100 grams, depending on the formulation.

### Example 4

A gluten free brownie mix (180 calories 50 grams) prepared with sugar, cocoa powder (or some cocoa powder blend), rice flour, potato starch, cornstarch, sea salt, natural flavor, guar gum, baking powder, and xanthan gum may have an approximate 29 grams of sugar, depending on the cocoa powder blend, and 2 grams of dietary fiber. By replacing the sugar with a naturally sweet fibrous blend similar to that described as Blend 6 or 7 in Table 1, assuming the cocoa powder has some inherent sugar therein that is not removed, the nutritional facts will change to approximately 5-7 grams of sugar per serving and 12-15 grams of fiber, depending on the concentration of isomalto-oligosaccharide present. Not only would sugars go down, but calories would also go down, and the grams of fat could also go down. For comparative purposes, granulated sugar has 400 calories per 100 grams whereas the naturally sweet fibrous blend of the present invention has an average caloric content of less than one half, i.e. about 180 calories per 100 grams, depending on the specific formulation.

### Example 5

A brownie mix (140 calories 32 grams) prepared to include sugar, enriched flour, chocolate chips, canola or soybean oil, natural cocoa, cocoa, wheat starch, salt, artificial flavor, and sodium bicarbonate may include about 18 grams of sugar and 1 gram of dietary fiber. By replacing the added sugar with a naturally sweet fibrous blend similar to that described as Blend 6 or 7 in Table 1, the sugars will drop to approximately 3 grams and dietary fiber will increase to about 8 grams. Not only would sugars go down, but calories would also go down and grams of fat could also go down. For comparative purposes, granulated sugar has 400 calories per 100 grams whereas the naturally sweet fibrous blend of the present invention has an average caloric content of less than one half, i.e. about 180 calories per 100 grams, depending on the formulation.

### Example 6

Quaker Instant Oats with maple brown sugar is prepared which includes whole grain rolled oats, sugar, natural and artificial flavor, salt, calcium carbonate, guar gum, caramel color, niacinamide, reduced iron, vitamin A palmitate, pyridoxine hydrochloride, riboflavin, thiamin mononitrate, and folic acid. A 43 gram serving of this formulation has 160 calories, 3 grams of dietary fiber, and 12 grams of sugar. On the other hand, a Quaker Instant Oatmeal with lower sugar content and maple brown sugar is prepared including whole grain rolled oats, sugar, natural and artificial flavor, salt, calcium carbonate, guar gum, caramel color, sucralose, niacinamide, reduced iron, vitamin A palmitate, pyridoxine hydrochloride, riboflavin, thiamin mononitrate, and folic acid. A formulation a 34 grams has 120 calories, 3 grams of dietary fiber, and 4 grams of sugar. In this example, the sucralose is used to lower the amount of sugar needed.

By using the naturally sweet fibrous blend of the present disclosure instead of the sugar and the sucralose, the sugar content would go to 0 grams per serving. Furthermore, by replacing sugar with the naturally sweet fibrous blend, the fiber count goes up and the calories go down, especially in recipes where sugar is one of the top three ingredients used.

### Example 7

Tables 2A-2E provide various blackberry syrup formulations where the components of the naturally sweet fibrous blend can be varied, and further compared with the formulation of Table 2F, which contains only sugar (sucrose) as the sweetener and no high fiber components. The blackberry syrup formulations illustrated in Tables 2A, 2B, 2C, and 2D are an improvement on the sugar sweetened formulation of Table 2E in terms of sweetness, viscosity, and storability, with the added advantages of higher fiber content and lower caloric content. The formulation of Table 2E is also an improvement in these areas, except that it is not as sweet.

TABLE 2A
Gluten Free Blackberry Syrup 1

| | Weight in | Amount |
|---|---|---|
| Ingredient | Grams (g) | (wt %) |
| Blackberry | 24 | 30.04 |
| Blackberry Flavor | 6 | 7.51 |
| Pectin | 3.75 | 4.69 |
| Xanthan Gum | 3 | 3.76 |
| Masking Agent | 0.84 | 1.05 |
| Sea Salt | 0.3 | 0.38 |
| Naturally sweet fibrous blend | 42 (total) | 52.57 (total) |
| (IMO:Tagatose:Stevia:Monk Fruit blended at | | |
| ~65:33:1:1 w/w) | | |
| i) isomalto-oligosaccharide | i) 27.3 | i) 34.17 |
| ii) tagatose | ii) 13.86 | ii) 17.35 |
| iii) stevia extract | iii) 0.42 | iii) 0.53 |
| iv) monk fruit extract | iv) 0.42 | iv) 0.53 |
| Final Formula Total | 79.89 | 100 |

Nutrition Facts:

| | |
|---|---|
| Serving Size: | ¼ Cup (7 grams) |
| Calories per Serving | 15 |
| Total Carbohydrates (g) | 6 |
| Dietary Fiber (g) | 3 |
| Sugars (g) | 1 |
| Protein (g) | 0 |
| Fat (g) | 0 |

The dietary fiber and sugar contents are factored into the total
carbohydrate amount.

TABLE 2B
Gluten Free Blackberry Syrup 2

| | Weight in | Amount |
|---|---|---|
| Ingredient | Grams (g) | (wt %) |
| Blackberry | 24 | 30.04 |
| Blackberry Flavor | 6 | 7.51 |
| Pectin | 3.75 | 4.69 |
| Xanthan Gum | 3 | 3.76 |
| Masking Agent | 0.84 | 1.05 |
| Sea Salt | 0.3 | 0.38 |
| Naturally sweet fibrous blend | 42 (total) | 52.57 (total) |
| (IMO:Tagatose:Stevia:Monk ruit blended at | | |
| ~50:48:1:1 w/w) | | |
| i) isomalto-oligosaccharide | i) 21 | i) 26.29 |
| ii) tagatose | ii) 20.16 | ii) 25.23 |
| iii) stevia extract | iii) 0.42 | iii) 0.53 |
| iv) monk fruit extract | iv) 0.42 | iv) 0.53 |
| Final Formula Total | 79.89 | 100 |

Nutrition Facts:

| | |
|---|---|
| Serving Size: | ¼ Cup (7 grams) |
| Calories per Serving | 15 |
| Total Carbohydrates (g) | 6 |
| Dietary Fiber (g) | 3 |
| Sugars (g) | 1 |
| Protein (g) | 0 |
| Fat (g) | 0 |

The dietary fiber and sugar contents are factored into the total
carbohydrate amount.

TABLE 2C
Gluten Free Blackberry Syrup 3

| | Weight in | Amount |
|---|---|---|
| Ingredient | Grams (g) | (wt %) |
| Blackberry | 24 | 30.04 |
| Blackberry Flavor | 6 | 7.51 |
| Pectin | 3.75 | 4.69 |
| Xanthan Gum | 3 | 3.76 |
| Masking Agent | 0.84 | 1.05 |
| Sea Salt | 0.3 | 0.38 |
| Naturally sweet fibrous blend | 42 (total) | 52.57 (total) |
| (IMO:Tagatose:Stevia:Monk Fruit blended at | | |
| ~50:48:1.2:0.8 w/w) | | |
| i) isomalto-oligosaccharide | i) 21 | i) 26.29 |
| ii) tagatose | ii) 20.16 | ii) 25.23 |
| iii) stevia extract | iii) 0.5 | iii) 0.63 |
| iv) monk fruit extract | iv) 0.34 | iv) 0.43 |
| Final Formula Total | 79.89 | 100 |

Nutrition Facts:

| | |
|---|---|
| Serving Size: | ¼ Cup (7 grams) |
| Calories per Serving | 15 |
| Total Carbohydrates (g) | 6 |
| Dietary Fiber (g) | 3 |
| Sugars (g) | 1 |
| Protein (g) | 0 |
| Fat (g) | 0 |

The dietary fiber and sugar contents are factored into the total
carbohydrate amount.

TABLE 2D
Gluten Free Blackberry Syrup 4

| | Weight in | Amount |
|---|---|---|
| Ingredient | Grams (g) | (wt %) |
| Blackberry | 24 | 30.04 |
| Blackberry Flavor | 6 | 7.51 |
| Pectin | 3.75 | 4.69 |
| Xanthan Gum | 3 | 3.76 |
| Masking Agent | 0.84 | 1.05 |
| Sea Salt | 0.3 | 0.38 |
| Naturally sweet fibrous blend | 42 (total) | 52.57 |
| | | (total) |
| (IMO:Tagatose:Stevia blended at ~50:48:2 w/w) | | |
| i) isomalto-oligosaccharide | i) 21 | i) 26.29 |
| ii) tagatose | ii) 20.16 | ii) 25.23 |
| iii) stevia extract* | iii) 0.84 | iii) 1.06 |
| Final Formula Total | 79.89 | 100 |

Nutrition Facts:

| | |
|---|---|
| Serving Size: | ¼ Cup (7 grams) |
| Calories per Serving | 15 |
| Total Carbohydrates (g) | 6 |
| Dietary Fiber (g) | 3 |
| Sugars (g) | 1 |
| Protein (g) | 0 |
| Fat (g) | 0 |

The dietary fiber and sugar contents are factored into the total
carbohydrate amount.

*Note that because only stevia extract is used rather than a blend of stevia extract and monk fruit extract, though the taste is pleasant, there is a slightly greater aftertaste.

TABLE 2E
Gluten Free Blackberry Syrup 5

| | Weight in | Amount |
|---|---|---|
| Ingredient | Grams (g) | (wt %) |
| Blackberry | 24 | 30.04 |
| Blackberry Flavor | 6 | 7.51 |
| Pectin | 3.75 | 4.69 |
| Xanthan Gum | 3 | 3.76 |
| Masking Agent | 0.84 | 1.05 |
| Sea Salt | 0.3 | 0.38 |
| *Naturally sweet fibrous blend (IMO:Tagatose | 42 (total) | 52.57 (total) |
| blended at ~50:50 w/w) | | |
| i) isomalto-oligosaccharide | i) 21 | i) 26.29 |
| ii) tagatose | ii) 21 | ii) 26.29 |
| Final Formula Total | 79.89 | 100 |

Nutrition Facts:

| | |
|---|---|
| Serving Size: | ¼ Cup (7 grams) |
| Calories per Serving | 15 |
| Total Carbohydrates (g) | 6 |
| Dietary Fiber (g) | 3 |
| Sugars (g) | 1 |
| Protein (g) | 0 |
| Fat (g) | 0 |

The dietary fiber and sugar contents are factored into the total
carbohydrate amount.

*Note that because a natural fruit extract is not used, similar fiber content is provided, but the syrup is not as sweet as the others in Tables 2A-2D.

TABLE 2F
Comparative Gluten Free Blackberry Syrup with Added Sugar

| Ingredient | Weight in Grams (g) | Amount (wt %) |
|---|---|---|
| Blackberry | 24 | 17.41 |
| Blackberry Flavor | 6 | 4.35 |
| Pectin | 3.75 | 2.72 |
| Xanthan Gum | 3 | 2.18 |
| Masking Agent | 0.84 | 0.61 |
| Sea Salt | 0.3 | 0.22 |
| Sugar (sucrose) | 100 | 72.52 |
| Final Formula Total | 137.89 | 100 |

Nutrition Facts:

| | |
|---|---|
| Serving Size: | ¼ Cup (7 grams) |
| Calories per Serving | 45 |
| Total Carbohydrates (g) | 11 |
| Dietary Fiber (g) | 1 |
| Sugars (g) | 10 |
| Protein (g) | 0 |
| Fat (g) | 0 |

The dietary fiber and sugar contents are factored into the total
carbohydrate amount.

In Table 2F above, unlike the syrup of Tables 2A-2E, there is minimal dietary fiber and the sugar comprises essentially all of the total carbohydrate content. The taste of all syrups is considered to be acceptable. However, blackberry syrup from Tables 2A-2E contain a high amount of fiber, and possess the advantages of lower caloric content, and the syrups from Tables 2A-2D are at least as sweet or sweeter than the formulation of Table 2F.

### Example 8

Tables 3A-3D show various pancake mix formulations wherein the components of the naturally sweet fibrous blend is varied, and furthermore, compared with the pancake formulation of Table 3E which contains only sugar (sucrose) as the sweetener and no high fiber content. The pancake mix formulations illustrated in Tables 3A, 3B, 3C, and 3D are an improvement over the sugar sweetened formulation of Table 3E in terms of sweetness, viscosity, and storability, with the advantages of higher fiber content and lower caloric content.

TABLE 3A
Gluten Free Pancake Mix 1

| | Weight in | Amount |
|---|---|---|
| Ingredient | Grams (g) | (wt %) |
| Flax Seed | 20 | 19.11 |
| Egg White Powder | 20 | 19.11 |
| Milk Protein Isolate | 15 | 14.33 |
| Oat Flour | 10 | 9.56 |
| Almond Flour | 10 | 9.56 |
| Butter Milk | 8 | 7.64 |
| Brown Rice Protein | 5 | 4.78 |
| Baking Powder | 4 | 3.82 |
| Butter Powder | 1 | 0.96 |
| Vanilla Powder | 0.75 | 0.72 |
| Baking Soda | 0.5 | 0.48 |
| Sea Salt | 0.25 | .024 |
| Cinnamon | 0.15 | 0.14 |
| Naturally sweet fibrous blend | 10 (total) | 9.56 (total) |
| (IMO:Tagatose:Stevia:Monk Fruit blended at | | |
| ~65:33:1:1 w/w) | | |
| i) isomalto-oligosaccharide | i) 6.5 | i) 6.21 |
| ii) tagatose | ii) 3.3 | ii) 3.15 |
| iii) stevia extract | iii) 0.1 | iii) 0.1 |
| iv) monk fruit extract | iv) 0.1 | iv) 0.1 |
| Final Formula Total | 104.65 | 100 |

Nutrition Facts:

| | |
|---|---|
| Serving Size: | 3.4 inch diameter pancake (52 grams) |
| Calories per Serving | 210 |
| Total Carbohydrates (g) | 18 |
| Dietary Fiber (g) | 6 |
| Sugars (g) | 3 |
| Protein (g) | 21 |
| Fat (g) | 7 |

The dietary fiber and sugar contents are factored into the total
carbohydrate amount.

TABLE 3B
Gluten Free Pancake Mix 2

| | Weight in | Amount |
|---|---|---|
| Ingredient | Grams (g) | (wt %) |
| Flax Seed | 20 | 19.11 |
| Egg White Powder | 20 | 19.11 |
| Milk Protein Isolate | 15 | 14.33 |
| Oat Flour | 10 | 9.56 |
| Almond Flour | 10 | 9.56 |
| Butter Milk | 8 | 7.64 |
| Brown Rice Protein | 5 | 4.78 |
| Baking Powder | 4 | 3.82 |
| Butter Powder | 1 | 0.96 |
| Vanilla Powder | 0.75 | 0.72 |
| Baking Soda | 0.5 | 0.48 |
| Sea Salt | 0.25 | .024 |
| Cinnamon | 0.15 | 0.14 |
| Naturally sweet fibrous blend | 10 (total) | 9.56 (total) |
| (IMO:Tagatose:Stevia:Monk Fruit blended at | | |
| ~81.3:17.7:0.5:0.5 w/w) | | |
| i) isomalto-oligosaccharide | i) 8.13 | i) 7.76 |
| ii) tagatose | ii) 1.77 | ii) 1.69 |
| iii) stevia extract | iii) 0.05 | iii) 0.05 |
| iv) monk fruit extract | iv) 0.05 | iv) 0.05 |
| Final Formula Total | 104.65 | 100 |

Nutrition Facts:

| | |
|---|---|
| Serving Size: | 3.4 inch diameter pancake (52 grams) |
| Calories per Serving | 200 |
| Total Carbohydrates (g) | 22 |
| Dietary Fiber (g) | 12 |
| Sugars (g) | 3 |
| Protein (g) | 21 |
| Fat (g) | 7 |

The dietary fiber and sugar contents are factored into the total
carbohydrate amount.

TABLE 3C
Gluten Free Pancake Mix 3

| | Weight in | Amount |
|---|---|---|
| Ingredient | Grams (g) | (wt %) |
| Flax Seed | 20 | 19.11 |
| Egg White Powder | 20 | 19.11 |
| Milk Protein Isolate | 15 | 14.33 |
| Oat Flour | 10 | 9.56 |
| Almond Flour | 10 | 9.56 |
| Butter Milk | 8 | 7.64 |
| Brown Rice Protein | 5 | 4.78 |
| Baking Powder | 4 | 3.82 |
| Butter Powder | 1 | 0.96 |
| Vanilla Powder | 0.75 | 0.72 |
| Baking Soda | 0.5 | 0.48 |
| Sea Salt | 0.25 | .024 |
| Cinnamon | 0.15 | 0.14 |
| Naturally sweet fibrous blend | 10 (total) | 9.56 (total) |
| (IMO:Tagatose:Stevia:Monk Fruit blended at | | |
| ~50:48:1:1 w/w) | | |
| i) isomalto-oligosaccharide | i) 5 | i) 4.78 |
| ii) tagatose | ii) 4.8 | ii) 4.59 |
| iii) stevia extract | iii) 0.1 | iii) 0.1 |
| iv) monk fruit extract | iv) 0.1 | iv) 0.1 |
| Final Formula Total | 104.65 | 100 |

Nutrition Facts:

| | |
|---|---|
| Serving Size: | 3.4 inch diameter pancake (52 grams) |
| Calories per Serving | 210 |
| Total Carbohydrates (g) | 19 |
| Dietary Fiber (g) | 6 |
| Sugars (g) | 3 |
| Protein (g) | 21 |
| Fat (g) | 7 |

The dietary fiber and sugar contents are factored into the total
carbohydrate amount.

TABLE 3D
Gluten Free Pancake Mix 4

| | Weight in | Amount |
|---|---|---|
| Ingredient | Grams (g) | (wt %) |
| Flax Seed | 20 | 19.11 |
| Egg White Powder | 20 | 19.11 |
| Milk Protein Isolate | 15 | 14.33 |
| Oat Flour | 10 | 9.56 |
| Almond Flour | 10 | 9.56 |
| Butter Milk | 8 | 7.64 |
| Brown Rice Protein | 5 | 4.78 |
| Baking Powder | 4 | 3.82 |
| Butter Powder | 1 | 0.96 |
| Vanilla Powder | 0.75 | 0.72 |
| Baking Soda | 0.5 | 0.48 |
| Sea Salt | 0.25 | .024 |
| Cinnamon | 0.15 | 0.14 |
| Naturally sweet fibrous blend | 10 (total) | 9.56 (total) |
| (IMO:Tagatose:Stevia:Monk Fruit blended at | | |
| ~65:33:1.2:0.8 w/w) | | |
| i) isomalto-oligosaccharide | i) 6.5 | i) 6.21 |
| ii) tagatose | ii) 3.3 | ii) 3.15 |
| iii) stevia extract | iii) 0.12 | iii) 0.11 |
| iv) monk fruit extract | iv) 0.08 | iv) 0.08 |
| Final Formula Total | 104.65 | 100 |

Nutrition Facts:

| | |
|---|---|
| Serving Size: | 3.4 inch diameter pancake (52 grams) |
| Calories per Serving | 210 |
| Total Carbohydrates (g) | 19 |
| Dietary Fiber (g) | 6 |
| Sugars (g) | 3 |
| Protein (g) | 21 |
| Fat (g) | 7 |

The dietary fiber and sugar contents are factored into the total
carbohydrate amount.

TABLE 3E
Comparative Gluten Free Pancake Mix with Added Sugar

| Ingredient | Weight in Grams (g) | Amount (wt %) |
|---|---|---|
| Almond Flour | 75 | 25.27 |
| Milk Protein Isolate | 50 | 16.85 |
| Sorghum Flour | 25 | 8.42 |
| Oat Flour | 25 | 8.42 |
| Potato Flour | 25 | 8.42 |
| Blueberry | 23 | 7.75 |
| Egg White Powder | 20 | 6.74 |
| Tapioca Flour | 20 | 6.74 |
| Baking Powder | 3 | 1.01 |
| Baking Soda | 2 | 0.67 |
| Blueberry Flavor | 2 | 0.67 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Sugar (sucrose) | 25 | 8.42 |
| Final Formula Total | 296.75 | 100 |

Nutrition Facts:

| | |
|---|---|
| Serving Size: | 3.4 inch diameter pancake (56 grams) |
| Calories per Serving | 200 |
| Total Carbohydrates (g) | 25 |
| Dietary Fiber (g) | 3 |
| Sugars (g) | 16 |
| Protein (g) | 20 |
| Fat (g) | 5 |

The dietary fiber and sugar contents are factored into the total
carbohydrate amount.

### Example 9

Tables 4A-4D show various blueberry muffin formulations where the components of the naturally sweet fibrous blend are varied, and further, compared with the formulation of Table 4E which contains only sugar (sucrose) as the sweetener and no high fiber components. The blueberry muffin formulations illustrated in Tables 4A, 4B, 4C, and 4D are an improvement over the sugar sweetened formulation of Table 4E in terms of sweetness, viscosity, and storability with the advantages of having higher fiber content and lower caloric content.

TABLE 4A
Gluten Free Blueberry Muffin Mix 1

| | Weight in | Amount |
|---|---|---|
| Ingredient | Grams (g) | (wt %) |
| Almond Flour | 75 | 24.86 |
| Milk Protein Isolate | 50 | 16.57 |
| Sorghum Flour | 25 | 8.29 |
| Oat Flour | 25 | 8.29 |
| Potato Flour | 25 | 8.29 |
| Blueberry | 23 | 7.62 |
| White Egg Powder | 20 | 6.63 |
| Tapioca Flour | 20 | 6.63 |
| Baking Powder | 3 | 0.99 |
| Baking Soda | 2.5 | 0.83 |
| Blueberry Flavor | 2 | 0.66 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Naturally sweet fibrous blend | 30 (total) | 9.94 (total) |
| (IMO:Tagatose:Stevia:Monk Fruit blended at | | |
| ~65:33:1:1 w/w) | | |
| i) isomalto-oligosaccharide | i) 19.5 | i) 6.46 |
| ii) tagatose | ii) 9.9 | ii) 3.28 |
| iii) stevia extract | iii) 0.3 | iii) 0.1 |
| iv) monk fruit extract | iv) 0.3 | iv) 0.1 |
| Final Formula Total | 301.75 | 100 |

Nutrition Facts:

| | |
|---|---|
| Serving Size: | One Muffin (25 grams) |
| Calories per Serving | 100 |
| Total Carbohydrates (g) | 12 |
| Dietary Fiber (g) | 3 |
| Sugars (g) | 2 |
| Protein (g) | 7 |
| Fat (g) | 4 |

The dietary fiber and sugar contents are factored into the total
carbohydrate amount.

TABLE 4B
Gluten Free Blueberry Muffin Mix 2

| | Weight in | Amount |
|---|---|---|
| Ingredient | Grams (g) | (wt %) |
| Almond Flour | 75 | 24.86 |
| Milk Protein Isolate | 50 | 16.57 |
| Sorghum Flour | 25 | 8.29 |
| Oat Flour | 25 | 8.29 |
| Potato Flour | 25 | 8.29 |
| Blueberry | 23 | 7.62 |
| White Egg Powder | 20 | 6.63 |
| Tapioca Flour | 20 | 6.63 |
| Baking Powder | 3 | 0.99 |
| Baking Soda | 2.5 | 0.83 |
| Blueberry Flavor | 2 | 0.66 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Naturally sweet fibrous blend | 30 (total) | 9.94 (total) |
| (IMO:Tagatose:Stevia:Monk Fruit blended at | | |
| ~81:18:0.5:0.5 w/w) | | |
| i) isomalto-oligosaccharide | i) 24.38 | i) 8.08 |
| ii) tagatose | ii) 5.32 | ii) 1.76 |
| iii) stevia extract | iii) 0.15 | iii) 0.05 |
| iv) monk fruit extract | iv) 0.15 | iv) 0.05 |
| Final Formula Total | 301.75 | 100 |

Nutrition Facts:

| | |
|---|---|
| Serving Size: | One Muffin (25 grams) |
| Calories per Serving | 100 |
| Total Carbohydrates (g) | 16 |
| Dietary Fiber (g) | 6 |
| Sugars (g) | 2 |
| Protein (g) | 7 |
| Fat (g) | 4 |

The dietary fiber and sugar contents are factored into the total
carbohydrate amount.

TABLE 4C
Gluten Free Blueberry Muffin Mix 3

| | Weight in | Amount |
|---|---|---|
| Ingredient | Grams (g) | (wt %) |
| Almond Flour | 75 | 24.86 |
| Milk Protein Isolate | 50 | 16.57 |
| Sorghum Flour | 25 | 8.29 |
| Oat Flour | 25 | 8.29 |
| Potato Flour | 25 | 8.29 |
| Blueberry | 23 | 7.62 |
| White Egg Powder | 20 | 6.63 |
| Tapioca Flour | 20 | 6.63 |
| Baking Powder | 3 | 0.99 |
| Baking Soda | 2.5 | 0.83 |
| Blueberry Flavor | 2 | 0.66 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Naturally sweet fibrous blend | 30 (total) | 9.94 (total) |
| (IMO:Tagatose:Stevia:Monk Fruit blended at | | |
| ~50:48:1:1 w/w) | | |
| i) isomalto-oligosaccharide | i) 15 | i) 4.97 |
| ii) tagatose | ii) 14.4 | ii) 4.77 |
| iii) stevia extract | iii) 0.3 | iii) 0.1 |
| iv) monk fruit extract | iv) 0.3 | iv) 0.1 |
| Final Formula Total | 301.75 | 100 |

Nutrition Facts:

| | |
|---|---|
| Serving Size: | One Muffin (25 grams) |
| Calories per Serving | 100 |
| Total Carbohydrates (g) | 13 |
| Dietary Fiber (g) | 3 |
| Sugars (g) | 2 |
| Protein (g) | 7 |
| Fat (g) | 4 |

The dietary fiber and sugar contents are factored into the total
carbohydrate amount.

TABLE 4D
Gluten Free Blueberry Muffin Mix 4

| | Weight in | Amount |
|---|---|---|
| Ingredient | Grams (g) | (wt %) |
| Almond Flour | 75 | 24.86 |
| Milk Protein Isolate | 50 | 16.57 |
| Sorghum Flour | 25 | 8.29 |
| Oat Flour | 25 | 8.29 |
| Potato Flour | 25 | 8.29 |
| Blueberry | 23 | 7.62 |
| White Egg Powder | 20 | 6.63 |
| Tapioca Flour | 20 | 6.63 |
| Baking Powder | 3 | 0.99 |
| Baking Soda | 2.5 | 0.83 |
| Blueberry Flavor | 2 | 0.66 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Naturally sweet fibrous blend | 30 (total) | 9.94 (total) |
| (IMO:Tagatose:Stevia:Monk Fruit blended at | | |
| ~65:33:1.2:0.8 w/w) | | |
| i) isomalto-oligosaccharide | i) 19.5 | i) 6.46 |
| ii) tagatose | ii) 9.9 | ii) 3.28 |
| iii) stevia extract | iii) 0.36 | iii) 0.12 |
| iv) monk fruit extract | iv) 0.24 | iv) 0.08 |
| Final Formula Total | 301.75 | 100 |

Nutrition Facts:

| | |
|---|---|
| Serving Size: | One Muffin (25 grams) |
| Calories per Serving | 100 |
| Total Carbohydrates (g) | 12 |
| Dietary Fiber (g) | 3 |
| Sugars (g) | 2 |
| Protein (g) | 7 |
| Fat (g) | 4 |

The dietary fiber and sugar contents are factored into the total
carbohydrate amount.

TABLE 4E
Comparative Gluten Free Blueberry Muffin Mix with Added Sugar

| Ingredient | Weight in Grams (g) | Amount (wt %) |
|---|---|---|
| Almond Flour | 75 | 24.86 |
| Milk Protein Isolate | 50 | 16.57 |
| Sorghum Flour | 25 | 8.29 |
| Oat Flour | 25 | 8.29 |
| Potato Flour | 25 | 8.29 |
| Blueberry | 23 | 7.62 |
| White Egg Powder | 20 | 6.63 |
| Tapioca Flour | 20 | 6.63 |
| Baking Powder | 3 | 0.99 |
| Baking Soda | 2.5 | 0.83 |
| Blueberry Flavor | 2 | 0.66 |
| Masking Agent | 0.6 | 0.2 |
| Vanilla Powder | 0.5 | 0.17 |
| Sea Salt | 0.5 | 0.17 |
| Cinnamon | 0.15 | 0.05 |
| Sugar (sucrose) | 75 | 21.63 |
| Final Formula Total | 346.75 | 100 |

Nutrition Facts:

| | |
|---|---|
| Serving Size: | One Muffin (25 grams) |
| Calories per Serving | 120 |
| Total Carbohydrates (g) | 16 |
| Dietary Fiber (g) | 1 |
| Sugars (g) | 8 |
| Protein (g) | 7 |
| Fat (g) | 4 |

The dietary fiber and sugar contents are factored into the total
carbohydrate amount.

### Example 10

Tables 5A-5E provides various brownie formulations wherein the components of the naturally sweet fibrous blend can be varied, and further, these formulations are compared with the formulation in Table 5E which contains only sugar (sucrose) as the sweetener and no high fiber components. The brownie formulations illustrated in Tables 5A, 5B, 5C, and 5D are equal to or better than the sugar sweetened formulation of Table 5D in terms of sweetness, viscosity, and storability with the advantages of higher fiber content and lower caloric content. The Table 5E formulation is not as sweet, but has similar other properties.

TABLE 5A
Gluten Free Brownie Mix 1

| | Weight in | Amount |
|---|---|---|
| Ingredient | Grams (g) | (wt %) |
| Almond Flour | 100 | 27.54 |
| Sorghum Flour | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| Naturally sweet fibrous blend | 80 (total) | 22.03 (total) |
| (IMO:Tagatose:Stevia:Monk Fruit blended at | | |
| ~65:33:1:1 w/w) | | |
| i) isomalto-oligosaccharide | i) 52 | i) 14.32 |
| ii) tagatose | ii) 26.4 | ii) 7.27 |
| iii) stevia extract | iii) 0.8 | iii) 0.22 |
| iv) monk fruit extract | iv) 0.8 | iv) 0.22 |
| Final Formula Total | 363.15 | 100 |

Nutrition Facts:

| | |
|---|---|
| Serving Size: | One Brownie (23 grams) |
| Calories per Serving | 80 |
| Total Carbohydrates (g) | 15 |
| Dietary Fiber (g) | 4 |
| Sugars (g) | 0 |
| Protein (g) | 2 |
| Fat (g) | 3.5 |

The dietary fiber and sugar contents are factored into the total
carbohydrate amount.

TABLE 5B
Gluten Free Brownie Mix 2

| | Weight in | Amount |
|---|---|---|
| Ingredient | Grams (g) | (wt %) |
| Almond Flour | 100 | 27.54 |
| Sorghum Flour | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| Naturally sweet fibrous blend | 80 (total) | 22.03 (total) |
| (IMO:Tagatose:Stevia:Monk | | |
| Fruit blended at ~50:48:1:1 w/w) | | |
| i) isomalto-oligosaccharide | i) 40 | i) 11.01 |
| ii) tagatose | ii) 38.4 | ii) 10.57 |
| iii) stevia extract | iii) 0.8 | iii) 0.22 |
| iv) monk fruit extract | iv) 0.8 | iv) 0.22 |
| Final Formula Total | 363.15 | 100 |

Nutrition Facts:

| | |
|---|---|
| Serving Size: | One Brownie (23 grams) |
| Calories per Serving | 80 |
| Total Carbohydrates (g) | 16 |
| Dietary Fiber (g) | 4 |
| Sugars (g) | 0 |
| Protein (g) | 2 |
| Fat (g) | 3.5 |

The dietary fiber and sugar contents are factored into the total
carbohydrate amount.

TABLE 5C
Gluten Free Brownie Mix 3

| | Weight in | Amount |
|---|---|---|
| Ingredient | Grams (g) | (wt %) |
| Almond Flour | 100 | 27.54 |
| Sorghum Flour | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| Naturally sweet fibrous blend | 80 (total) | 22.03 (total) |
| (IMO:Tagatose:Stevia:Monk | | |
| Fruit blended at ~50:48:1.2:0.8 w/w) | | |
| i) isomalto-oligosaccharide | i) 40 | i) 11.01 |
| ii) tagatose | ii) 38.4 | ii) 10.57 |
| iii) stevia extract | iii) 0.96 | iii) 0.26 |
| iv) monk fruit extract | iv) 0.64 | iv) 0.18 |
| Final Formula Total | 363.15 | 100 |

Nutrition Facts:

| | |
|---|---|
| Serving Size: | One Brownie (23 grams) |
| Calories per Serving | 80 |
| Total Carbohydrates (g) | 15 |
| Dietary Fiber (g) | 4 |
| Sugars (g) | 0 |
| Protein (g) | 2 |
| Fat (g) | 3.5 |

The dietary fiber and sugar contents are factored into the total
carbohydrate amount.

TABLE 5D
Gluten Free Brownie Mix 4

| | Weight in | Amount |
|---|---|---|
| Ingredient | Grams (g) | (wt %) |
| Almond Flour | 100 | 27.54 |
| Sorghum Flour | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| Naturally sweet fibrous blend | 80 (total) | 22.03 (total) |
| (IMO:Tagatose:Monk | | |
| Fruit blended at ~50:48:2 w/w) | | |
| i) isomalto-oligosaccharide | i) 40 | i) 11.01 |
| ii) tagatose | ii) 38.4 | ii) 10.57 |
| iii) monk fruit extract* | iii) 1.6 | iii) 0.44 |
| Final Formula Total | 363.15 | 100 |

Nutrition Facts:

| | |
|---|---|
| Serving Size: | One Brownie (23 grams) |
| Calories per Serving | 80 |
| Total Carbohydrates (g) | 16 |
| Dietary Fiber (g) | 4 |
| Sugars (g) | 0 |
| Protein (g) | 2 |
| Fat (g) | 4 |

The dietary fiber and sugar contents are factored into the total
carbohydrate amount.

*Note that because only monk fruit extract is used rather than a blend of stevia extract and monk fruit extract, though the taste is pleasant, there is a slightly greater aftertaste.

TABLE 5E
Gluten Free Brownie Mix 5 without Natural Extract

| | Weight in | Amount |
|---|---|---|
| Ingredient | Grams (g) | (wt %) |
| Almond Flour | 100 | 27.54 |
| Sorghum Flour | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| *Naturally sweet fibrous blend | 80 (total) | 22.03 (total) |
| (IMO:Tagatose blended at ~50:50 w/w) | | |
| i) isomalto-oligosaccharide | i) 40 | i) 11.01 |
| ii) tagatose | ii) 40 | ii) 11.01 |
| Final Formula Total | 363.15 | 100 |

Nutrition Facts:

| | |
|---|---|
| Serving Size: | One Brownie (23 grams) |
| Calories per Serving | 80 |
| Total Carbohydrates (g) | 16 |
| Dietary Fiber (g) | 4 |
| Sugars (g) | 0 |
| Protein (g) | 2 |
| Fat (g) | 4 |

The dietary fiber and sugar contents are factored into the total
carbohydrate amount.

*Note that because a natural fruit extract is not used, the same fiber content is provided, but the brownie produced from the mix is not as sweet as the others in Tables 5A-5D.

TABLE 5F
Comparative Gluten Free Brownie Mix with Added Sugar

| | Weight in Grams | |
|---|---|---|
| Ingredient | (g) | Amount (wt %) |
| Almond Flour | 100 | 27.54 |
| Sorghum ur | 100 | 27.54 |
| Natural Cocoa | 25 | 6.88 |
| Potato Flour | 25 | 6.88 |
| Tapioca Flour | 25 | 6.88 |
| Sea Salt | 2.25 | 0.62 |
| Xanthan Gum | 2 | 0.55 |
| Milk Chocolate Natural Flavor | 1.8 | 0.5 |
| Masking Agent | 1.6 | 0.44 |
| Vanilla Powder | 0.25 | 0.07 |
| Baking Soda | 0.25 | 0.07 |
| Sugar (sucrose) | 200 | 41.4 |
| Final Formula Total | 483.15 | 100 |

Nutrition Facts:

| | |
|---|---|
| Serving Size: | One Brownie (23 grams) |
| Calories per Serving | 120 |
| Total Carbohydrates (g) | 23 |
| Dietary Fiber (g) | 2 |
| Sugars (g) | 13 |
| Protein (g) | 2 |
| Fat (g) | 3.5 |

The dietary fiber and sugar contents are factored into the total
carbohydrate amount.

### Example 11

Tables 6A-6C show various cookie formulations wherein the components of the naturally sweet fibrous blend are varied and compared with the formulations of Table 6D. Table 6D provides a cookie mix which contains only sugar (sucrose) as the sweetener and no high fiber components. The cookie formulations illustrated in Tables 6A, 6B, and 6C are an improvement on the sugar sweetened cookie formulation of Table 6D in terms of sweetness, viscosity, and storability with the advantages of higher fiber content and lower caloric content.

TABLE 6A
Gluten Free Cookie Mix 1

| | Weight in | Amount |
|---|---|---|
| Ingredient | Grams (g) | (wt %) |
| Rice Flour | 150 | 38 |
| Sorghum Flour | 150 | 38 |
| Potato Starch | 25 | 6.33 |
| Xanthan Gum | 5 | 1.27 |
| Baking Powder | 2 | 0.51 |
| Masking Agent | 1.2 | 0.3 |
| Vanilla Powder | 1 | 0.25 |
| Sea Salt | 0.5 | 0.13 |
| Naturally sweet fibrous blend | 60 (total) | 15.2 (total) |
| (IMO:Tagatose:Stevia:Monk | | |
| Fruit blended at ~65:33:1:1 w/w) | | |
| i) isomalto-oligosaccharide | i) 39 | i) 9.88 |
| ii) tagatose | ii) 19.8 | ii) 5.02 |
| iii) stevia extract | iii) 0.6 | iii) 0.15 |
| iv) monk fruit extract | iv) 0.6 | iv) 0.15 |
| Final Formula Total | 394.7 | 100 |

Nutrition Facts:

| | |
|---|---|
| Serving Size: | One Cookie (20 grams) |
| Calories per Serving | 70 |
| Total Carbohydrates (g) | 16 |
| Dietary Fiber (g) | 2 |
| Sugars (g) | 0 |
| Protein (g) | 1 |
| Fat (g) | 0 |

The dietary fiber and sugar contents are factored into the total
carbohydrate amount.

TABLE 6B
Gluten Free Cookie Mix 2

| | Weight in | Amount |
|---|---|---|
| Ingredient | Grams (g) | (wt %) |
| Rice Flour | 150 | 38 |
| Sorghum Flour | 150 | 38 |
| Potato Starch | 25 | 6.33 |
| Xanthan Gum | 5 | 1.27 |
| Baking Powder | 2 | 0.51 |
| Masking Agent | 1.2 | 0.3 |
| Vanilla Powder | 1 | 0.25 |
| Sea Salt | 0.5 | 0.13 |
| Naturally sweet fibrous blend | 60 (total) | 15.2 (total) |
| (IMO:Tagatose:Stevia:Monk | | |
| Fruit blended at ~50:48:1:1 w/w) | | |
| i) isomalto-oligosaccharide | i) 30 | i) 7.6 |
| ii) tagatose | ii) 28.8 | ii) 7.3 |
| iii) stevia extract | iii) 0.6 | iii) 0.15 |
| iv) monk fruit extract | iv) 0.6 | iv) 0.15 |
| Final Formula Total | 394.7 | 100 |

Nutrition Facts:

| | |
|---|---|
| Serving Size: | One Cookie (20 grams) |
| Calories per Serving | 70 |
| Total Carbohydrates (g) | 17 |
| Dietary Fiber (g) | 2 |
| Sugars (g) | 0 |
| Protein (g) | 1 |
| Fat (g) | 0 |

The dietary fiber and sugar contents are factored into the total
carbohydrate amount.

TABLE 6C
Gluten Free Cookie Mix 3

| | Weight in | Amount |
|---|---|---|
| Ingredient | Grams (g) | (wt %) |
| Rice Flour | 150 | 38 |
| Sorghum Flour | 150 | 38 |
| Potato Starch | 25 | 6.33 |
| Xanthan Gum | 5 | 1.27 |
| Baking Powder | 2 | 0.51 |
| Masking Agent | 1.2 | 0.3 |
| Vanilla Powder | 1 | 0.25 |
| Sea Salt | 0.5 | 0.13 |
| Naturally sweet fibrous blend | 60 (total) | 15.2 (total) |
| (IMO:Tagatose:Stevia:Monk | | |
| Fruit blended at ~65:33:1.2:0.8 w/w) | | |
| i) isomalto-oligosaccharide | i) 39 | i) 9.88 |
| ii) tagatose | ii) 19.8 | ii) 5.02 |
| iii) stevia extract | iii) 0.72 | iii) 0.18 |
| iv) monk fruit extract | iv) 0.48 | iv) 0.12 |
| Final Formula Total | 394.7 | 100 |

Nutrition Facts:

| | |
|---|---|
| Serving Size: | One Cookie (20 grams) |
| Calories per Serving | 70 |
| Total Carbohydrates (g) | 16 |
| Dietary Fiber (g) | 2 |
| Sugars (g) | 0 |
| Protein (g) | 1 |
| Fat (g) | 0 |

The dietary fiber and sugar contents are factored into the total
carbohydrate amount.

TABLE 6D
Comparative Gluten Free Cookie Mix with Added Sugar

| Ingredient | Weight in Grams (g) | Amount (wt %) |
|---|---|---|
| Rice Flour | 150 | 30.95 |
| Sorghum Flour | 150 | 30.95 |
| Potato Starch | 25 | 5.17 |
| Xanthan Gum | 5 | 1 |
| Baking Powder | 2 | 0.42 |
| Masking Agent | 1.2 | 0.25 |
| Vanilla Powder | 1 | 0.21 |
| Sea Salt | 0.5 | 0.1 |
| Sugar (sucrose) | 150 | 30.95 |
| Final Formula Total | 484.7 | 100 |

Nutrition Facts:

| | |
|---|---|
| Serving Size: | One Cookie (24 grams) |
| Calories per Serving | 90 |
| Total Carbohydrates (g) | 21 |
| Dietary Fiber (g) | 1 |
| Sugars (g) | 8 |
| Protein (g) | 1 |
| Fat (g) | 0 |

The dietary fiber and sugar contents are factored into the total
carbohydrate amount.

### Example 12

Tables 7A-7C show various Cran/Raspberry Drink Mix wherein the components of the naturally sweet fibrous compound can be varied, and further compared with the formulation of Example 7D which contains only sugar (sucrose) as the sweetener and no high fiber components. Drink formulations illustrated in Tables 7A, 7B, and 7C are an improvement on the sugar sweetened drink formulation of Example 7D in terms of sweetness, viscosity, and storability with the advantages of having higher fiber content and lower caloric content.

TABLE 7A
Cran/Raspberry Drink Mix 1

| | Weight in | Amount |
|---|---|---|
| Ingredient | Grams (g) | (wt %) |
| Raspberry Flavor | 0.5 | 5.52 |
| Cranberry Flavor | 0.4 | 4.42 |
| Masking Agent | 0.16 | 1.77 |
| Naturally sweet fibrous blend | 8 (total) | 88.3 (total) |
| (IMO:Tagatose:Stevia:Monk | | |
| Fruit blended at ~65:33:1:1 w/w) | | |
| i) isomalto-oligosaccharide | i) 5.2 | i) 57.4 |
| ii) tagatose | ii) 2.64 | ii) 29.14 |
| iii) stevia extract | iii) 0.08 | iii) 0.88 |
| iv) monk fruit extract | iv) 0.08 | iv) 0.88 |
| Final Formula Total | 9.06 | 100 |

Nutrition Facts:

| | |
|---|---|
| Serving Size: | 4.5 g |
| Calories per Serving | 10 |
| Total Carbohydrates (g) | 4 |
| Dietary Fiber (g) | 2 |
| Sugars (g) | 0 |
| Protein (g) | 0 |
| Fat (g) | 0 |

The dietary fiber and sugar contents are factored into the total
carbohydrate amount.

TABLE 7B
Cran/Raspberry Drink Mix 2

| | Weight in | Amount |
|---|---|---|
| Ingredient | Grams (g) | (wt %) |
| Raspberry Flavor | 0.5 | 5.52 |
| Cranberry Flavor | 0.4 | 4.42 |
| Masking Agent | 0.16 | 1.77 |
| Naturally sweet fibrous blend | 8 (total) | 88.3 (total) |
| (IMO:Tagatose:Stevia:Monk | | |
| Fruit blended at ~50:48:1:1 w/w) | | |
| i) isomalto-oligosaccharide | i) 4 | i) 44.15 |
| ii) tagatose | ii) 3.84 | ii) 42.38 |
| iii) stevia extract | iii) 0.08 | iii) 0.88 |
| iv) monk fruit extract | iv) 0.08 | iv) 0.88 |
| Final Formula Total | 9.06 | 100 |

Nutrition Facts:

| | |
|---|---|
| Serving Size: | 4.5 g |
| Calories per Serving | 10 |
| Total Carbohydrates (g) | 5 |
| Dietary Fiber (g) | 2 |
| Sugars (g) | 0 |
| Protein (g) | 0 |
| Fat (g) | 0 |

The dietary fiber and sugar contents are factored into the total
carbohydrate amount.

TABLE 7C
Cran/Raspberry Drink Mix 3

| | Weight in | Amount |
|---|---|---|
| Ingredient | Grams (g) | (wt %) |
| Raspberry Flavor | 0.5 | 5.52 |
| Cranberry Flavor | 0.4 | 4.42 |
| Masking Agent | 0.16 | 1.77 |
| Naturally sweet fibrous blend | 8 (total) | 88.3 (total) |
| (IMO:Tagatose:Stevia:Monk | | |
| Fruit blended at ~65:33:1.2:0.8 w/w) | | |
| i) isomalto-oligosaccharide | i) 5.2 | i) 57.4 |
| ii) tagatose | ii) 2.64 | ii) 29.14 |
| iii) stevia extract | iii) 0.096 | iii) 1.06 |
| iv) monk fruit extract | iv) 0.064 | iv) 0.71 |
| Final Formula Total | 9.06 | 100 |

Nutrition Facts:

| | |
|---|---|
| Serving Size: | 4.5 g |
| Calories per Serving | 10 |
| Total Carbohydrates (g) | 4 |
| Dietary Fiber (g) | 2 |
| Sugars (g) | 0 |
| Protein (g) | 0 |
| Fat (g) | 0 |

The dietary fiber and sugar contents are factored into the total
carbohydrate amount.

TABLE 7D
Comparative Cran/Raspberry Drink Mix with Added Sugar

| Ingredient | Weight in Grams (g) | Amount (wt %) |
|---|---|---|
| Raspberry Flavor | 0.5 | 1.92 |
| Cranberry Flavor | 0.4 | 1.53 |
| Masking Agent | 0.16 | 0.61 |
| Sugar (sucrose) | 25 | 95.93 |
| Final Formula Total | 26.06 | 100 |

Nutrition Facts:

| | |
|---|---|
| Serving Size: | *13 g |
| Calories per Serving | 50 |
| Total Carbohydrates (g) | 13 |
| Dietary Fiber (g) | 0 |
| Sugars (g) | 13 |
| Protein (g) | 1 |
| Fat (g) | 0 |

The dietary fiber and sugar contents are factored into the total
carbohydrate amount.

*As a note, more sugar can be used to achieve equal sweetness compared to that which the naturally sweet fibrous blend provides. For example, the naturally sweet fibrous blend may use more grams than an artificial sweetener, but can be formulated to use less refined sugar, such as is the case in this particular drink mix product.

### Example 13

A (dark or milk) chocolate composition which includes the naturally sweet fibrous blend according to the present disclosure, prepared at a serving size of 100 grams or 40 grams, may typically contain about following when, rounded to the nearest gram:

TABLE 8A

Serving Size
(grams)

| | 100 | 40 |
|---|---|---|
| Calories | 439 | 176 |
| Fat (grams) | 41 | 17 |
| Total Carbohydrates | 31 | 13 |
| (grams) | | |
| Active Carbohydrates | 13 | 5 |
| (grams) | | |
| Dietary Fiber (grams) | 19 | 8 |
| Sugars (grams) | 1 | 0 |
| Protein | 8 | 3 |

More detailed listings of the 40 gram formulation of Table 8A compared with 40 gram servings of other commercial chocolate compositions, in bar form, are listed and also rounded to the nearest gram. The five (5) commercial chocolate products (Lindt, Green & Black; Divine Chocolate; Theo; and Ghirardelli) were averaged in the following Table. The individual commercial chocolate bars had higher carbs, sugar, etc., but are averaged for convenience below in Table 8B.

TABLE 8B

| | | | Average | |
|---|---|---|---|---|
| | | | of 5 Commercial | |
| | Table 8A Chocolate | | Chocolate Products | |
| Serving Size | 40 | grams | 40 | grams |
| Servings per Bar | 2.5 | | 2.5 | |
| Calories per Serving | 176 | | 228 | |
| Percent Cocoa | 70 | wt % | 70 | wt % |
| Total Fat per Serving | 17 | grams | 17 | grams |
| Total Carbohydrates per | 12 | grams | 18 | grams |
| Serving | | | | |
| Active Carbohydrates per | 4 | grams | 14 | grams |
| Serving | | | | |
| Dietary Fiber per Serving | 8 | grams | 4 | grams |
| Sugars per Serving | 0 | grams | 4 | grams |
| Protein per Serving | 3 | grams | 3 | grams |

From Table 8B above, it is evident that the by using the naturally sweet fibrous blend of the present disclosure rather than sugar, as described herein, a chocolate product can be prepared with fewer calories, fewer active carbohydrates, and fewer sugars; and at the same time, provides increased beneficial fiber intake.

### Example 14

### Granule Sweetener Taste Test

A standalone naturally sweet fibrous blend, similar to that found in a sweetener package for adding to coffee, was taste tested by 10 individuals. In that taste test, 10 out of 10 people preferred the naturally sweet fibrous blend's mouth feel and taste compared to sugar alcohols, artificial sweeteners, and intense natural sweeteners. More surprisingly, 5 out of 10 people actually preferred the taste and mouth feel of the naturally sweet fibrous blend to sugar. Some reported that the sweetener blend had a pleasant cool or fresh aftertaste. Additionally, 8 out 10 preferred the naturally sweet fibrous blend taste and mouth feel to agave nectar powder.

### Example 15

### Syrup Taste Test

A powdered syrup recipe was formulated with the naturally sweet fibrous blend of the present disclosure for taste testing. In that study, all 10 individuals participating reported that they did not like sugar free or no added sugar products generally. In that study, the syrup recipe was liked by 10 out of 10 consumers.

### Example 16

### Brownie Taste Test

A brownie formulation developed with the naturally sweet fibrous blend of the present disclosure, similar to that shown in Examples 5A-5C, was found to have a very acceptable taste by 10 individuals, even though it is sugar free and gluten free.

### Example 17

### Chocolate Taste Tests

For confectionery items such as chocolate, the naturally sweet fibrous blend or blend of the present disclosure offers a sweetness profile that is not only better than what is offered by artificial sweeteners, sugar alcohols, and intense natural sweeteners (or even intense natural sweetener/sugar alcohol blends), but for many samplers, it was found that the taste was even better than refined sugar sweetened chocolate and Maltitol (sugar free) sweetened chocolate for some testers.

For example, in a taste test of 10 individuals, all that sampled a chocolate sweetened with the naturally sweet fibrous blend or blend of the present disclosure found the taste pleasant. This turned out to be unexpected because other than sugar, no other sweetener has heretofore been particularly successful in sweetening chocolate to a commercially satisfactory taste, other than perhaps Maltitol, which only allows consumers to eat chocolate products sparingly without suffering digestive problems. The naturally sweet fibrous blend or blend of the present disclosure offers a sugar free, sugar alcohol free, dark chocolate and a sugar alcohol free, no sugar added milk chocolate which is pleasant tasting, i.e. still tastes like sugar sweetened chocolate. Additionally, blends prepared in accordance with examples of the present disclosure can be added to dark chocolate instead of sugar.

With further detail regarding the taste test, 4 out of 10 taste testers preferred the naturally sweet fibrous blend-sweetened chocolate of the present disclosure to a sugar chocolate blend; 4 of the 10 liked it as much, but not better than sugar sweetened chocolate; and only 2 of the 10 preferred the sugar sweetened chocolate. However, the two who found the sugar sweetened chocolate more appealing indicated that they still liked the chocolate sweetened using the naturally sweet fibrous blend of the present disclosure.

In further detail, in a similar study, a cocoa was studied where naturally sweet fibrous blend (used over sugar) was reported to actually enhance the cocoa flavoring to some degree, resulting in many samplers believing that the chocolate contained a much better roast, quality, and higher cocoa content in cocoa nibs and cocoa butter than really existed.

### Example 18

### Powdered Drink Mix Taste Tests

Six (6) powdered drink mixes were developed and tested by 20 individuals for taste. All 20 taste testers in the sampling enjoyed the taste of the drink mixes without the need for the addition of typical acids (citric acid, malic acid, and/or ascorbic acid) used in many popular powder drink mixes to enhance the flavor profile to an acceptable level for consumers. These formulated powder drink blends can thus be prepared without the need for added acid flavor enhancers. Furthermore, the individuals indicated that the mouth feel and taste was once again considered to be clean and cool, yet not artificial or chemical tasting.

While the disclosure has been described with reference to certain embodiments, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A naturally sweet fibrous blend, comprising:
from 15 wt % to 85 wt % natural isomalto-oligosaccharide;
from 10 wt % to 75 wt % by weight of tagatose; and
from 0.05 wt % to 20 wt % of a natural sweetener extract.

2. The naturally sweet fibrous blend of claim 1, wherein the natural sweetener extract comprises stevia extract, monk fruit extract, or a combination of both stevia extract and monk fruit extract.

3. The naturally sweet fibrous blend of claim 2, wherein both the stevia extract and the monk fruit extract are both present in the naturally sweet fibrous blend.

4. The naturally sweet fibrous blend of claim 3, wherein stevia extract is present at from 0.1 wt % to 3 wt %, and wherein the monk fruit extract is present at from 0.1 wt % to 3 wt %.

5. The naturally sweet fibrous blend of claim 3, wherein stevia extract is present at from 0.1 wt % to 1 wt %, and wherein the monk fruit extract is present at from 0.1 wt % to 1 wt %.

6. The naturally sweet fibrous blend of claim 3, wherein composition comprises:
from 15 wt % to 75 wt % natural isomalto-oligosaccharide;
from 15 wt % to 75 wt % by weight of tagatose;
from 1 wt % to 15 wt % stevia extract; and
from 1 wt % to 15 wt % monk fruit extract.

7. The naturally sweet fibrous blend of claim 1, wherein the composition is free of artificial sweeteners.

8. The naturally sweet fibrous blend of claim 1, wherein the composition is free of sugar alcohols.

9. The naturally sweet fibrous blend of claim 1, wherein the composition is free of artificial sweeteners and sugar alcohols.

10. The naturally sweet fibrous blend of claim 1, wherein the isomalto-oligosaccharide is present at a greater concentration than the tagatose.

11. The naturally sweet fibrous blend of claim 3, wherein the stevia extract is present at a greater concentration than the monk fruit extract.

12. The naturally sweet fibrous blend of claim 1, said blend being from 95% to 150% as sweet as sugar and formulated to have from 75% to 125% the volume of sugar.

13. The naturally sweet fibrous blend of claim 1, said blend being at least as sweet as sugar and having from 90% to 110% the volume of sugar, or about 100% the volume of sugar (i.e. about 1:1 by volume).

14. The naturally sweet fibrous blend of claim 1, said blend having about the same sweetness as sugar and being formulated to have from 75% to 125% the volume of sugar.

15. The naturally sweet fibrous blend of claim 3, wherein composition comprises:
from 40 wt % to 60 wt % isomalto-oligosaccharide,
from 40 wt % to 60 wt % tagatose,
from 0.1 wt % to 3 wt % by weight stevia extract, and
from 0.1 wt % to 3 wt % by weight monk fruit extract.

16. The naturally sweet fibrous blend of claim 3, wherein composition comprises:
from 60 wt % to 70 wt % isomalto-oligosaccharide,
from 30 wt % to 40 wt % tagatose,
from 0.1 wt % to 3 wt % by weight stevia extract, and
from 0.1 wt % to 3 wt % by weight monk fruit extract.

17. The naturally sweet fibrous blend of claim 3, wherein composition comprises:
from 70 wt % to 85 wt % isomalto-oligosaccharide,
from 10 wt % to 30 wt % tagatose,
from 0.1 wt % to 3 wt % by weight stevia extract, and
from 0.1 wt % to 3 wt % by weight monk fruit extract.

18. A food product sweetened by a naturally sweet fibrous blend, comprising:
the food product; and
the naturally sweet fibrous blend of claim 1.

19. The food product of claim 18, wherein the natural sweetener extract comprises stevia extract, monk fruit extract, or a combination of both stevia extract and monk fruit extract.

20. The food product of claim 19, wherein both the stevia extract and the monk fruit extract are both present in the naturally sweet fibrous blend.

21. The food product of claim 20, wherein stevia extract is present at from 0.1 wt % to 3 wt % relative to the naturally sweet fibrous blend, and wherein the monk fruit extract is present at from 0.1 wt % to 3 wt % relative to the naturally sweet fibrous blend.

22. The food product of claim 20, wherein stevia extract is present at from 0.1 wt % to 1 wt % relative to the naturally sweet fibrous blend, and wherein the monk fruit extract is present at from 0.1 wt % to 1 wt % relative to the naturally sweet fibrous blend.

23. The food product of claim 20, wherein the naturally sweet fibrous blend comprises:
from 15 wt % to 75 wt % natural isomalto-oligosaccharide;
from 15 wt % to 75 wt % by weight of tagatose;
from 1 wt % to 15 wt % stevia extract; and
from 1 wt % to 15 wt % monk fruit extract.

24. The food product of claim 18, said product being devoid of sugar.

25. The food product of claim 18, said product being devoid of artificial sweetener.

26. The food product of claim 18, said product being devoid of sugar alcohols.

27. The food product of claim 18, wherein the food product is a baking mix.

28. The food product of claim 18, wherein the food product is a drink mix concentrate.

29. The food product of claim 18, wherein the food product is a ready to drink liquid beverage.

30. The food product of claim 18, wherein the food product is a food supplement.

31. The food product of claim 18, wherein the food product is a snack food.

32. The food product of claim 18, wherein the food product is a breakfast food.

33. The food product of claim 18, wherein the food product is a dairy product.

34. The food product of claim 18, wherein the food product is a condiment.

35. The food product of claim 18, wherein the food product is a chocolate.

36. The food product of claim 18, wherein the food product is a candy.

37. A method of sweetening a food product without added sugar, comprising:
formulating a food product; and
admixing into the food product, as part of formulating, a naturally sweet fibrous blend comprising at least isomalto-oligosaccharide and tagatose.

38. The method of claim 37, wherein the formulating further comprises adding an ingredient to the food product that is sweeter than sugar.

39. The method of claim 37, wherein the ingredient that is sweeter than sugar is a natural extract and is part of the naturally sweet fibrous blend.

40. The method of claim 39, wherein the natural extract is selected from the group consisting of stevia extract, monk fruit extract, and mixtures thereof.

41. The method of claim 37, wherein the step of formulating the food product includes omitting addition of any sugar alcohols and artificial sweeteners.

42. The method of claim 37, wherein the food product is a baking mix, a drink mix concentrate, a ready to drink liquid beverage, a food supplement, a snack food, a breakfast food, a dairy product, a condiment, a chocolate, or a candy.

43. A naturally sweet fibrous blend suitable for sweetening food or beverage products, comprising:
from 30 wt % to 90 wt % isomalto-oligosaccharide; and
from 10 wt % to 70 wt % tagatose.

44. The naturally sweet fibrous blend of claim 43, wherein the isomalto-oligosaccharide is present at a greater concentration than the tagatose.

45. The naturally sweet fibrous blend of claim 43, wherein composition comprises:
from 30 wt % to 40 wt % isomalto-oligosaccharide, and
from 60 wt % to 70 wt % tagatose.

46. The naturally sweet fibrous blend of claim 43, wherein composition comprises:
from 40 wt % to 60 wt % isomalto-oligosaccharide, and
from 40 wt % to 60 wt % tagatose.

47. The naturally sweet fibrous blend of claim 43, comprising:
from 60 wt % to 70 wt % isomalto-oligosaccharide, and
from 30 wt % to 40 wt % tagatose.

48. The naturally sweet fibrous blend of claim 43, wherein composition comprises:
from 70 wt % to 90 wt % isomalto-oligosaccharide, and
from 10 wt % to 30 wt % tagatose.

49. The naturally sweet fibrous blend of claim 43, further comprising stevia extract.

50. The naturally sweet fibrous blend of claim 43, further comprising monk fruit extract.

51. The naturally sweet fibrous blend of claim 43, further comprising stevia extract and monk fruit extract.

52. A food product sweetened by a naturally sweet fibrous blend, comprising:
the food product; and
the naturally sweet fibrous blend of claim 1.
